(19) United States
(12) Patent Application Publication
(10) Pub. No.: US 2025/0352000 A1
(43) Pub. Date: Nov. 20, 2025

(54) Coffee Bean Grinder

(71) Applicant: Ricco Rosini, Old Hickory, TN (US)

(72) Inventors: Ricco Rosini, Old Hickory, TN (US); Sascha Retailleau, San Francisco, CA (US); Mark Sires, Santa Cruz, CA (US)

(21) Appl. No.: 18/664,677

(22) Filed: May 15, 2024

(51) Int. Cl. A47J 42/40; A47J 42/06; A47J 42/10; A47J 42/16; A47J 42/20; A47J 42/46; A47J 42/50

(52) U.S. Cl. CPC A47J 42/40; A47J 42/06; A47J 42/10; A47J 42/16; A47J 42/20; A47J 42/46; A47J 42/50

(57) ABSTRACT

A coffee bean grinder comprising a housing and a cartridge. The housing may be configured to receive coffee beans. The cartridge may be removably couplable to the housing and include a cartridge base, a cartridge top, a grinding chamber, and a grinding device. The cartridge top may be removably coupled to the cartridge base. The grinding chamber may be defined between the cartridge base and the cartridge top. The grinding device may be positioned within the grinding chamber and configured to grind coffee beans received in the housing into coffee grounds.

### BACKGROUND

### 1. Field of Invention

The present invention relates generally to a grinding device. More particularly, this invention relates to a coffee bean grinder having a housing and a cartridge removably coupled thereto.

### 2. Description of the Prior Art

Coffee is the second most consumed beverage in the United States behind water. Various methods of preparing coffee exist, but many consumers are limited based on what tools they have at their disposal. While some consumers buy pre-ground coffee beans, certain advantages exist to grinding the coffee beans immediately before preparing the coffee. Typically, low-cost coffee bean grinders intended for home use do not include all of the features and abilities of high-end industrial and commercial coffee bean grinders used by coffee manufacturers and coffee shops. One downside of low-cost coffee bean grinders is that they are typically unable to maintain a consistent ground size, sometimes producing coffee grounds with size variations up to 1000 microns or more. Other downsides associated with low-cost coffee bean grinders are their inability to swap burrs, inability to adjust coffee ground size, and tendency to trap coffee grounds within the coffee bean grinder. For example, coffee grounds may become trapped within the grinding chamber, the burrs, and/or the exit chute.

High-end coffee bean grinders may allow certain elements to be swapped or replaced. However, this is typically not an easy process, often requiring tools and a substantial amount of machine downtime. In a commercial setting, this machine downtime can result in lost sales. One element that may be swapped on some high-end coffee bean grinders are the burrs or the burr carrier. However, swapping the burrs and/or the burr carrier requires tools, and in some cases specialty tools, to remove and replace fasteners mounting such components within the coffee bean grinder. When mounting the burrs and/or the burr carrier, a user must ensure the burrs are properly aligned, which often requires shimming the burr carrier and/or burrs leading to extended down time. In these coffee bean grinders, if the burrs are misaligned or not positioned parallel to one another, the coffee bean grinder may not function properly. Oftentimes, the burrs in commercial and/or high-end coffee bean grinders are specialized such that the burrs may be an excellent choice for one purpose but a poor choice for another. For example, the burrs may be excellent for preparing grounds for espresso, but less than adequate for preparing grounds for a French press. Another disadvantage of prior art coffee bean grinders is the coffee bean grinders are typically limited to the size and type of burr that comes standard with the grinder.

Accordingly, a need exists for improvements in coffee bean grinders.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect in accordance with the present disclosure is a coffee bean grinder comprising a housing and a cartridge. The housing may be configured to receive coffee beans. The cartridge may be removably couplable to the housing and include a cartridge base, a cartridge top, a grinding chamber, and a grinding device. The cartridge top may be removably coupled to the cartridge base. The grinding chamber may be defined between the cartridge base and the cartridge top. The grinding device may be positioned within the grinding chamber and configured to grind coffee beans received in the housing into coffee grounds.

In accordance with other aspects of the present disclosure, the grinding device may include a pair of burrs. The cartridge may be configured to receive a conical pair of burrs and a flat pair of burrs.

In accordance with other aspects of the present disclosure, the pair of burrs may include a first burr and a second burr. The second burr may be coupled to a rotatable base plate. The first burr may be coupled to the cartridge top. The second burr may be configured to selectively rotate relative to the first burr.

In accordance with other aspects of the present disclosure, the cartridge base may be configured to receive the coffee grounds from the grinding device. The cartridge may include a plurality of sweeper arms coupled to the base plate. The plurality of sweeper arms may be configured to direct the coffee grounds in the cartridge base to an exit of the cartridge base.

In accordance with other aspects of the present disclosure, the coffee bean grinder may further comprise an exit chute configured to receive the coffee grounds from the cartridge and direct the coffee grounds to a desired location.

In accordance with other aspects of the present disclosure, the coffee bean grinder may further comprise a vibrator assembly associated with the exit chute. The vibrator assembly may be configured to selectively vibrate the exit chute.

In accordance with other aspects of the present disclosure, the coffee bean grinder may further comprise a rotatable drive shaft configured to rotate at least a portion of the grinding chamber. The drive shaft may be configured to vibrate the exit chute via the vibrator assembly.

In accordance with other aspects of the present disclosure, the vibrator assembly may include a cylindrical plunger and a vibration block. The vibration block may be coupled on a first side to the exit chute and on a second side to the cylindrical plunger. The drive shaft may include a tabbed portion. The tabbed portion of the drive shaft may be configured to intermittently contact the cylindrical plunger when the drive shaft rotates such that the vibration assembly vibrates the exit chute.

In accordance with other aspects of the present disclosure, the coffee bean grinder may further comprise one or more sensors associated with the coffee bean grinder. The one or more sensors may be configured to detect an operating characteristic of the coffee bean grinder.

In accordance with other aspects of the present disclosure, the coffee bean grinder may further comprise one or more sensors associated with the coffee bean grinder. The one or more sensors may be configured to detect a characteristic of the cartridge removably coupled to the coffee bean grinder.

In accordance with other aspects of the present disclosure, the coffee bean grinder may further comprise a prebreaker removably coupled to the cartridge. The prebreaker may be cylindrically shaped and at least partially extend through the cartridge top. The prebreaker may be configured to direct coffee beans into the grinding chamber of the cartridge.

In accordance with other aspects of the present disclosure, the coffee bean grinder may further comprise a selector 286 configured to selectively adjust a characteristic of the grinding device.

In accordance with other aspects of the present disclosure, the grinding device may include a pair of burrs. The cartridge may be configurable in a flat configuration wherein the cartridge receives a pair of flat burrs and a conical configuration wherein the cartridge receives a pair of conical burrs.

In accordance with other aspects of the disclosure, the cartridge is configurable in a combination configuration wherein the cartridge receives at least one flat burr and at least one conical burr.

Another aspect in accordance with the present disclosure is a cartridge configured to be removably couplable to a coffee bean grinder. The cartridge may comprise a cartridge base, a cartridge top, a grinding chamber, and a pair of burrs. The cartridge top may be removably coupled to the cartridge base. The grinding chamber may be defined between the cartridge base and the cartridge top. The pair of burrs may be received by the grinding chamber and configured to grind coffee beans into coffee grounds. A first burr of the pair of burrs may be arranged substantially parallel to a second burr of the pair of burrs. The first burr may be connected to the cartridge top and fixed relative thereto. The second burr may be operably connectable to a shaft and configured to be rotatably driven thereby.

In accordance with other aspects of the present disclosure, the cartridge may be configured to receive a conical pair of burrs and a flat pair of burrs.

In accordance with other aspects of the present disclosure, the second burr may be coupled to a rotatable base plate and configured to selectively rotate relative to the first burr.

In accordance with other aspects of the present disclosure, the cartridge base may be configured to receive the coffee grounds from the pair of burrs. The cartridge may further include a plurality of sweeper arms coupled to a base plate. The plurality of sweeper arms may be configured to direct the coffee grounds in the cartridge base to an exit of the cartridge base.

In accordance with other aspects of the present disclosure, the coffee bean grinder may further comprise one or more sensors associated with the cartridge. The one or more sensors may be configured to detect an operating characteristic of the cartridge.

In accordance with other aspects of the present disclosure, the cartridge may be configured such that the pair of burrs may be selectively removed and replaced by a second pair of burrs.

Numerous objects, features, and advantages of the present invention will be readily apparent to those skilled in the art upon a review of the following description in conjunction with the accompanying drawings.

### BRIEF DESCRIPTION OF THE DRAWINGS

FIG. 1 is a top perspective view of an exemplary embodiment of a coffee bean grinder in accordance with the present disclosure.

FIG. 2 is a front elevation view of the coffee bean grinder of FIG. 1.

FIG. 3 is a side elevation view of the coffee bean grinder of FIG. 1.

FIG. 4 is a top view of the coffee bean grinder of FIG. 1.

FIG. 5 is a cross-sectional view of the coffee bean grinder of FIG. 1.

FIG. 6 is a top perspective view of the coffee bean grinder of FIG. 1 wherein portions of a housing of the coffee bean grinder are removed.

FIG. 7 is a top perspective view of the coffee bean grinder of FIG. 1 wherein portions of the housing are removed.

FIG. 8 is a top perspective view of a cartridge, cartridge support, and rotatable drive shaft of the coffee bean grinder of FIG. 1.

FIG. 9 is a bottom perspective view of the cartridge and rotatable drive shaft of FIG. 8.

FIG. 10 is a side elevation view of the cartridge and rotatable drive shaft of FIG. 8.

FIG. 11 is a top perspective view of the cartridge of FIG. 8.

FIG. 12 is a top perspective view of the cartridge of FIG. 8 wherein a cartridge top is removed and the cartridge base includes flat burrs having a first diameter.

FIG. 13 is a top perspective view of the cartridge of FIG. 8 wherein a cartridge top is removed and the cartridge base includes flat burrs having a second diameter.

FIG. 14 is a bottom view of a cartridge base of the cartridge of FIG. 8.

FIG. 14A is a cross-sectional view of the cartridge base of FIG. 14 wherein the cartridge base includes flat burrs having the second diameter.

FIG. 14B is a perspective cross-sectional view of the cartridge base of FIG. 14 wherein the cartridge base includes flat burrs having the second diameter.

FIG. 14C is a cross-sectional view of the cartridge base of FIG. 14 wherein the cartridge base includes flat burrs having the second diameter.

FIG. 14D is a perspective cross-sectional view of the cartridge base of FIG. 14 wherein the cartridge base includes flat burrs having the second diameter.

FIG. 15 is a bottom view of a cartridge base of the cartridge of FIG. 8.

FIG. 15A is a cross-sectional view of the cartridge base of FIG. 15 wherein the cartridge base includes flat burrs having the first diameter.

FIG. 15B is a perspective cross-sectional view of the cartridge base of FIG. 15 wherein the cartridge base includes flat burrs having the first diameter.

FIG. 15C is a cross-sectional view of the cartridge base of FIG. 15 wherein the cartridge base includes flat burrs having the first diameter.

FIG. 15D is a perspective cross-sectional view of the cartridge base of FIG. 15 wherein the cartridge base includes flat burrs having the first diameter.

FIG. 16 is a top perspective view of the coffee bean grinder of FIG. 1 wherein a user is pressing a lever of the coffee bean grinder.

FIG. 17 is a top perspective view of the coffee bean grinder of FIG. 1 wherein a lid of the coffee bean grinder is removed to expose the cartridge.

FIG. 18 is a schematic view of a controller of the coffee bean grinder of FIG. 1.

### DETAILED DESCRIPTION

Reference will now be made in detail to embodiments of the present disclosure, one or more drawings of which are set forth therein. Each drawing is provided by way of explanation of the present disclosure and is not a limitation. It will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended to limit the broader aspects of the present disclosure.

The words “connected,” “attached,” “joined,” “mounted,” “fastened,” and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

Unless specifically stated otherwise, any part of the apparatus of the present disclosure may be made of any appropriate or suitable material including, but not limited to, metal, alloy, polymer, polymer mixture, wood, composite, or any combination thereof. Furthermore, any part of the apparatus of the present disclosure may be made using any applicable manufacturing method, such as, but not limited to 3D printing, injection molding, or the like.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is inclusive, and not exclusive. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or multiple components.

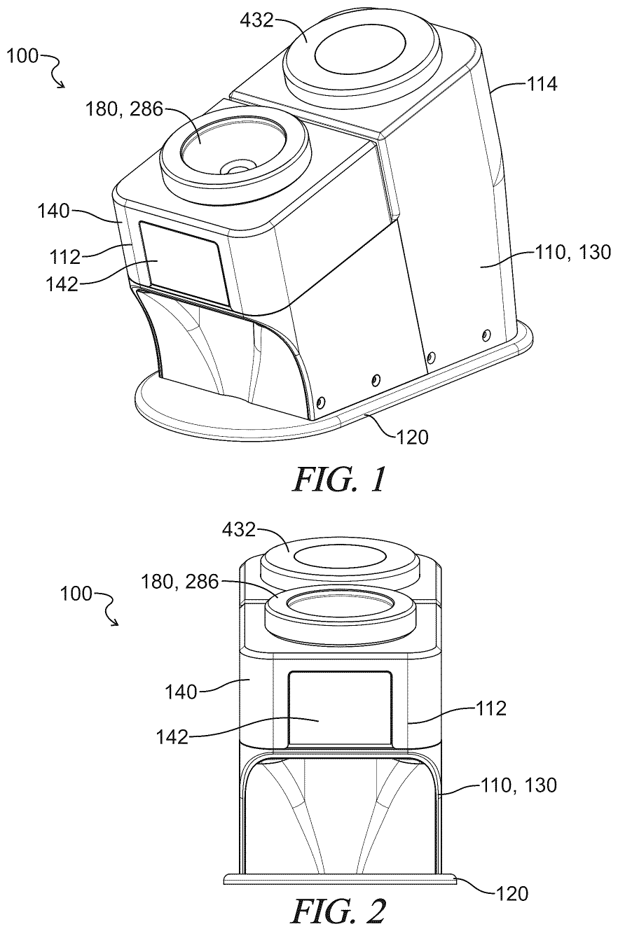

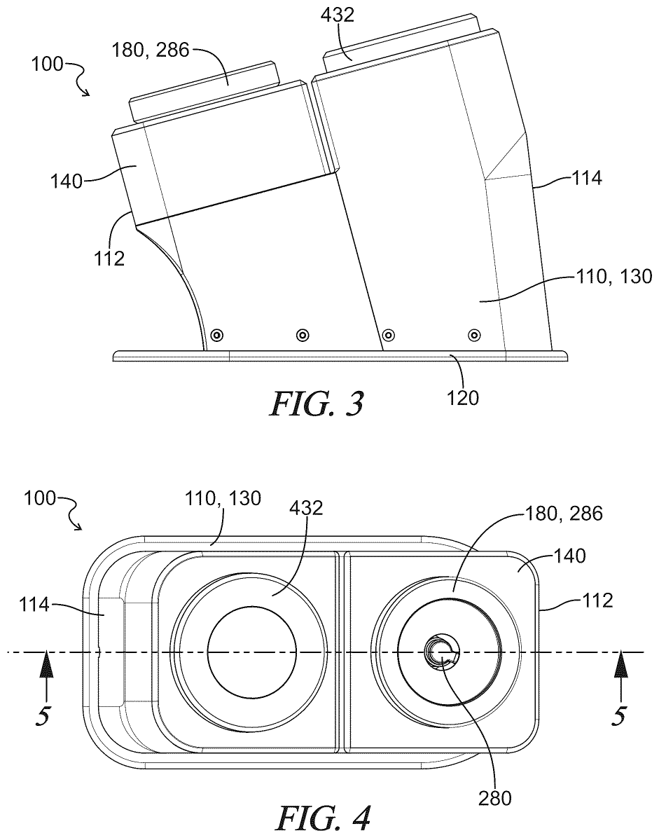

Referring now to the figures, and specifically FIGS. 1-3, an embodiment of a coffee bean grinder is shown and generally referred to as number 100. The coffee bean grinder 100 may be configured to grind coffee beans into coffee grounds.

The coffee bean grinder 100 may include a housing 110. The housing 110 may include a base 120, outer shell 130, and lid 140. The base 120 of the housing 110 may be configured to support the coffee bean grinder 100 from a substantially flat surface. The outer shell 130 may extend up from the base 120 and define an interior of the housing 110. The housing 110 may have a front end 112 and a back end 114. The front end 112 may correspond to an end of the housing 110 from which a user may approach or interact with the coffee bean grinder 100. However, one of skill in the art will recognize that the coffee bean grinder 100 may be positioned in other ways relative to a user.

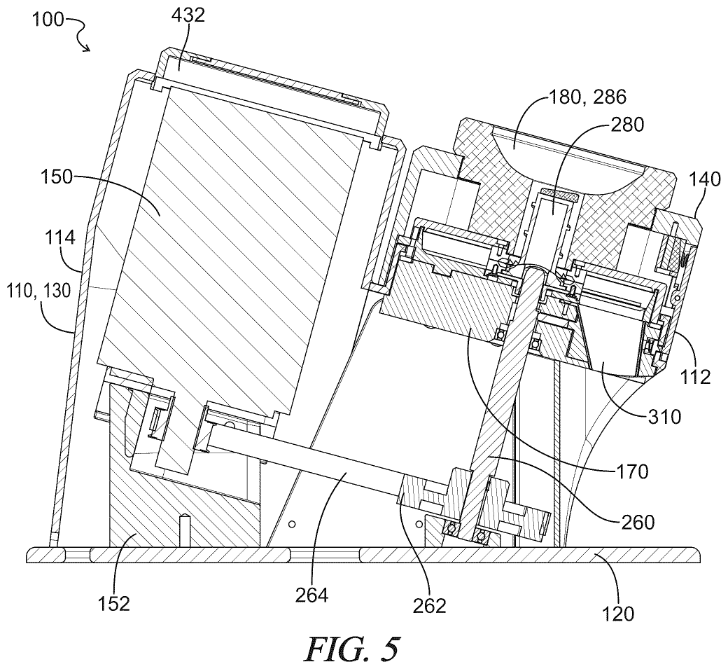

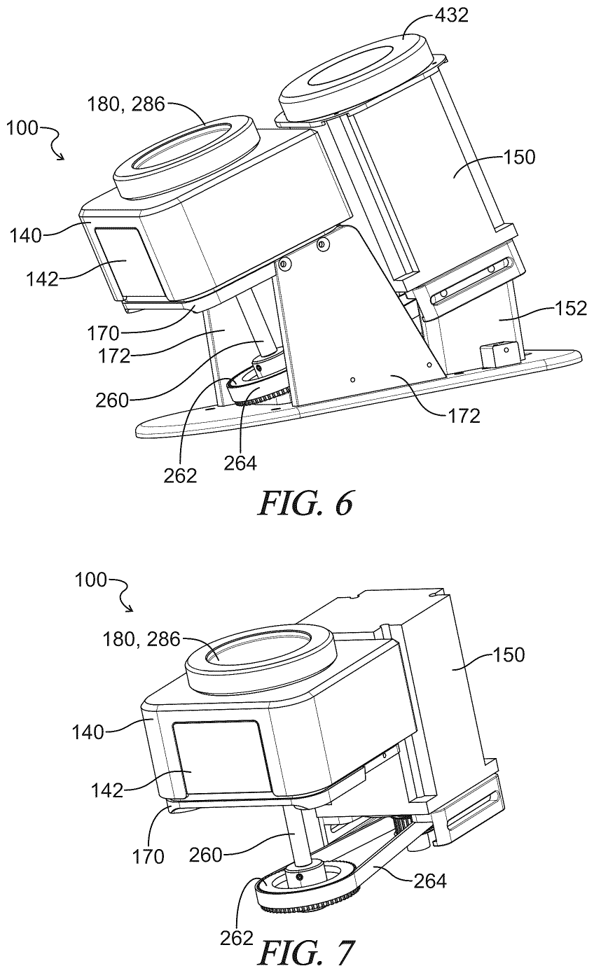

The coffee bean grinder 100 may include a motor 150, as shown in FIGS. 5-7. In accordance with certain aspects of the disclosure, the motor 150 may be an electric motor or the like. The motor 150 may be mounted to the base 120 via a motor mount 152. The motor 150 and motor mount 152 may be positioned closer to the back end 114 of the base 120 than the front end 112 of the base 120. The motor mount 152 may position the motor 150 such that the motor 150 is angled relative to the base 120 of the housing 110.

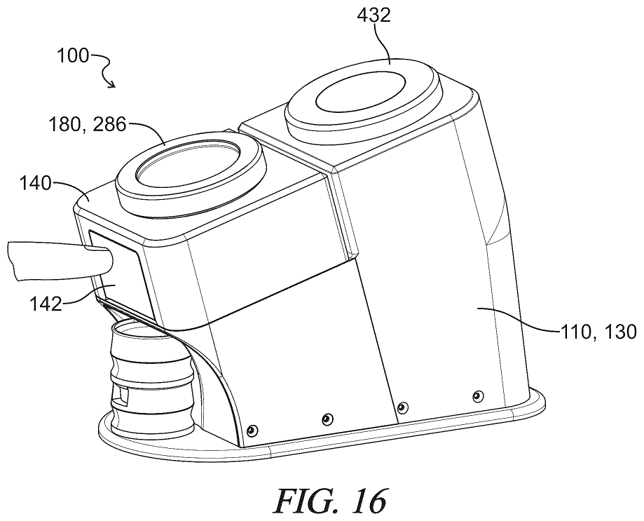

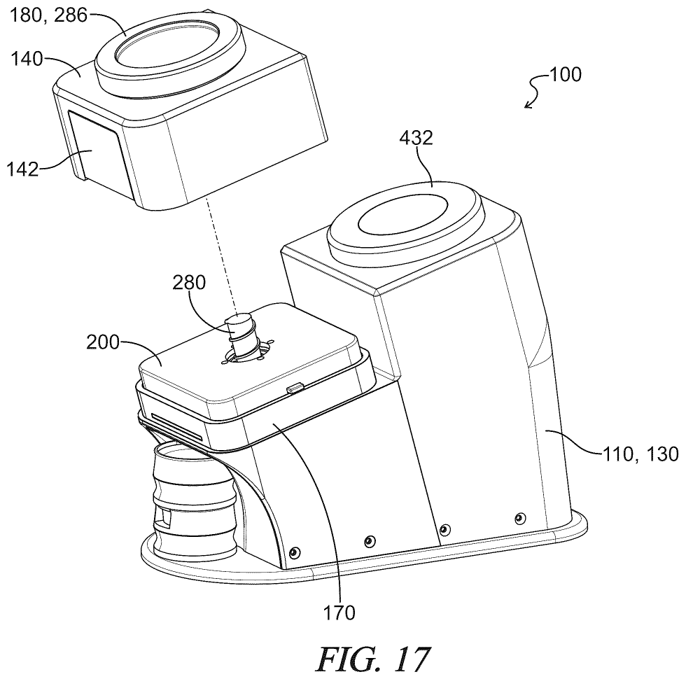

In accordance with certain aspects of the disclosure, the lid 140 may be coupled, attached, or otherwise connected to the outer shell 130. In accordance with other aspects of the disclosure, the lid 140 may be coupled to other elements of the coffee bean grinder 100 but positioned adjacent to the outer shell 130. The lid 140 may be selectively moveable between an open position and a closed position. In the open position, the user may be able to access elements of the coffee bean grinder 100 positioned within the interior of the housing 110. In the closed position, the interior of the housing 110 may be substantially enclosed. In accordance with certain aspects of the disclosure, the lid 140 may be configured to pivot relative to the outer shell 130 between the open position and the closed position. In accordance with other aspects of the disclosure, the lid 140 may be removably coupled to the outer shell 130 such that the lid may be removed and replaced to access elements of the coffee bean grinder 100 positioned within the interior of the housing 110. The lid 140 may include a lever 142 operably coupled to the lid 140. The lever 142 may be configured to selectively couple the lid 140 in the closed position. FIG. 16 shows a user pressing the lever 142 and FIG. 17 shows the lid 140 removed from the remaining portions of the housing 110 such that the cartridge 200 is exposed. In accordance with other aspects of the disclosure, the lid 140 may be slid along a rail or similar apparatus between the open position and closed position. In accordance with other aspects of the disclosure, the lid 140 may be configured to translate relative to or pivot about a display 432. Thus, the cylindrical shape of the display 432 may serve as a post that the lid 140 moves relative to.

The housing 110 may further include a cartridge support 170, as shown in FIGS. 5-8. The cartridge support 170 may be supported from the base 120 by a plurality of vertical supports 172. In accordance with certain aspects of the disclosure, the cartridge support 170 may be positioned at an angle relative the base 120. The cartridge support 170 may be shaped such that it corresponds to the shape of a cartridge 200 associated with the coffee bean grinder 100.

The housing 110 may be configured to receive coffee beans. More specifically, the housing 110 may be configured to receive coffee beans via an intake member 180. In accordance with certain aspects of the disclosure, the intake member 180 may be generally cylindrical in shape and may include a central hole. As shown in FIG. 5, interior walls of the intake member 180 may be angled such that the internal walls funnel coffee beans towards the central hole. The intake member 180 may be configured to direct coffee beans into the cartridge 200 of the coffee bean grinder.

In accordance with certain aspects of the disclosure, the cartridge 200 may be removably couplable to the housing 110, and more specifically to the cartridge support 170 of the housing 110. When coupled to the housing 110, the cartridge 200 may be positioned beneath the lid 140 and supported by the cartridge support 170. The cartridge 200 may be accessible by a user when the lid 140 is removed or moved to the open position. In accordance with certain aspects of the disclosure, the cartridge 200 may be accessible by a user without manipulating the lid 140.

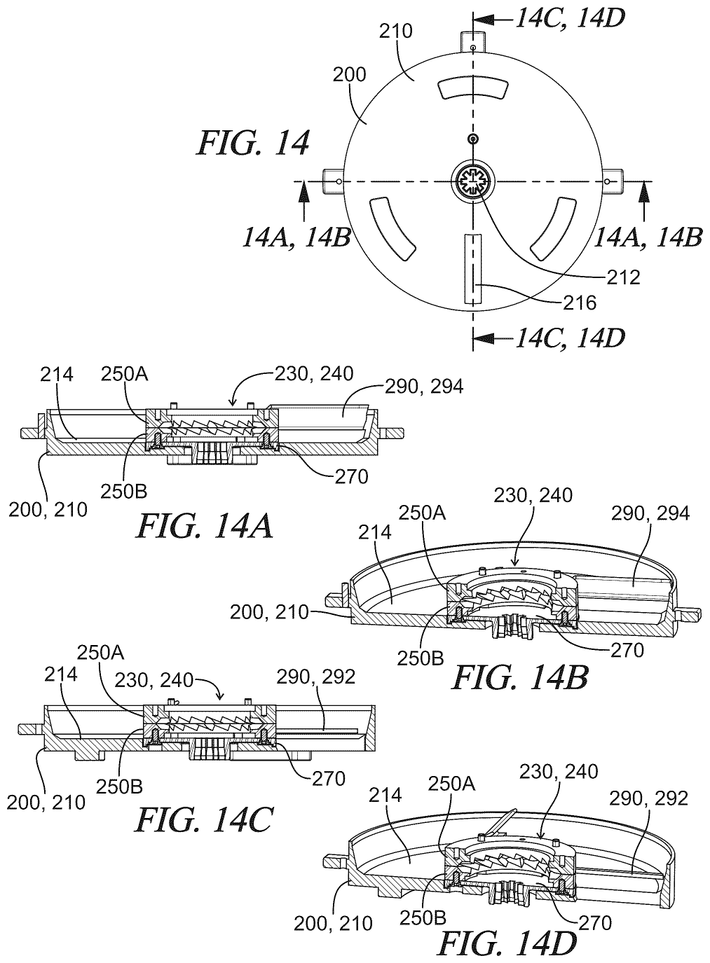

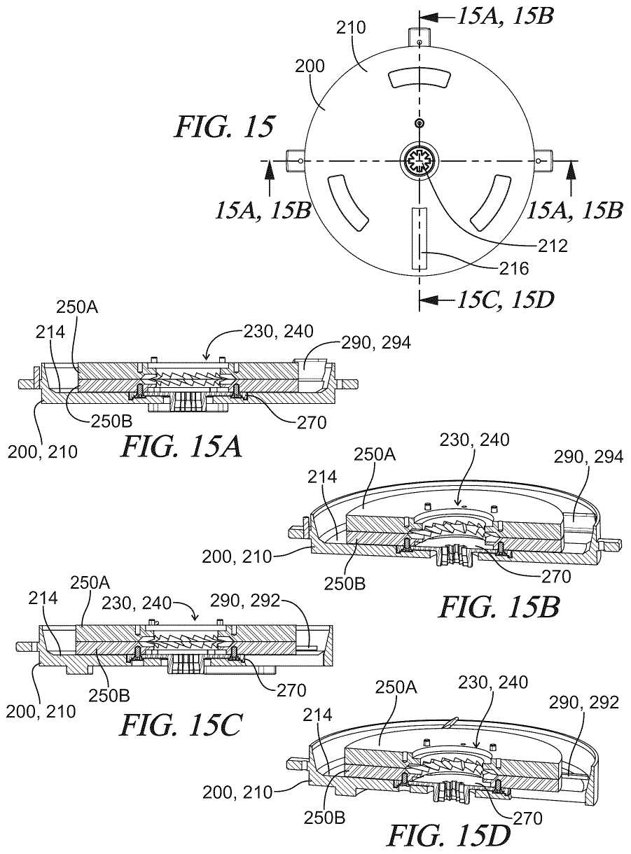

In accordance with certain aspects of the disclosure, elements of the cartridge 200 may center and align the cartridge 200 relative to the cartridge support 170. As shown in FIGS. 14 and 15, protrusions at approximately, the twelve, four, and eight o'clock positions of the cartridge 200 may align with or otherwise correspond to depressions or like features of the cartridge support 170. Further, tabs extending from the cartridge 200 at approximately the twelve, three, and nine o'clock positions may align with or otherwise correspond to cutouts or like features of the cartridge support 170. One of skill in the art will recognize there may be any number of protrusions and/or tabs and the protrusions and/or tabs may be positioned at various portions of the cartridge 200.

Lever 142 may selectively couple the lid 140 to the cartridge support 170. When lever 142 is actuated, the lid 140 may be movable relative to the cartridge support 170. When the lever is not actuated, the lid 140 may be fixed relative to the cartridge support 170. The cartridge support 170 may include a locking piece configured to selectively couple the cartridge 200 to the cartridge support 170. When the lever is actuated, the lever 142 may contact the locking piece thus allowing the cartridge 200 to decouple from the cartridge support 170. When the lever is not actuated, the lever 142 may not contact the locking piece and the cartridge 200 may be coupled to the cartridge support 170. In accordance with certain aspects of the disclosure, the locking piece may include one or more pins which extend/retract to lock/unlock the cartridge 200 relative to the cartridge support 170.

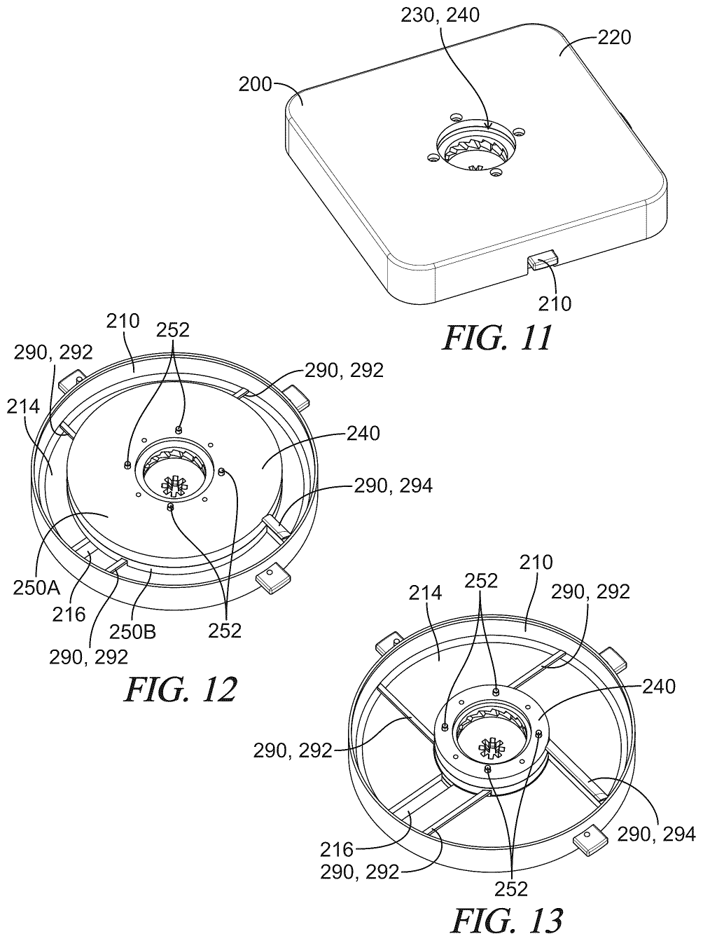

Referring now to FIGS. 9-15D, the cartridge 200 may include a cartridge base 210, a cartridge top 220, a grinding chamber 230, and a grinding device 240. The cartridge top 220 may be removably coupled to the cartridge base 210. In accordance with certain aspects of the disclosure, the cartridge top 220 may be generally rectangular in shape with rounded corners. The cartridge top 220 may include a generally circular recessed area defined therein. In accordance with certain aspects of the disclosure, the cartridge base 210 may be generally circular in shape and configured to be received within the recessed area of the cartridge top 220. When the cartridge top 220 is coupled to the cartridge base 210, the grinding chamber 230 may be defined between the cartridge base 210 and the cartridge top 220.

The grinding device 240 may be positioned within the grinding chamber 230 and configured to grind coffee beans received in the housing 110 into coffee grounds. The grinding device 240 may include a pair of burrs 250. The pair of burrs 250 may include a first burr 250A and a second burr 250B. In accordance with certain aspects of the disclosure, the first burr 250A may be positioned above the second burr 250B such that the first burr 250A is a top burr and the second burr 250B is a bottom burr. The cartridge 200 may be configured to receive different types/shapes of burrs. In accordance with certain aspects of the disclosure, the cartridge 200 may be configured to receive a conical pair of burrs and a flat pair of burrs (shown in FIGS. 12-15). Thus, a single cartridge 200 may be used in association with both a conical pair of burrs and a flat pair of burrs. The first and second burrs 250A, 250B of FIGS. 12 and 15A-15D have a first diameter. The first and second burrs 250A, 250B of FIGS. 13 and 14A-D have a second diameter. The first diameter may be larger than the second diameter.

The cartridge may be configurable in a flat configuration, a conical configuration, and a combination configuration. In the flat configuration, the cartridge receives a pair of flat burrs. In the conical configuration, the cartridge receives a pair of conical burrs. In the combination configuration, the cartridge receives at least one flat burr and at least one conical burr. For example, the cartridge may receive a pair of flat burrs and an additional conical burr or an additional pair of conical burrs.

While two exemplary pairs of burrs 250 are listed, the cartridge 200 may also be configured to receive burrs of other types/shapes. The first and second burrs 250A, 250B may be configured such that they may be coupled/decoupled from the cartridge 200 without tools. The first and second burrs 250A, 250B may be coupled to the cartridge 200 mechanically, magnetically, or by other coupling methods.

The cartridge 200 may be configured such that when the first and second burrs 250A, 250B are coupled to the cartridge 200, the first and second burrs 250A, 250B are substantially parallel to one another and to the cartridge base 210 and cartridge top 220. The cartridge 200 may be further configured such that when the first and second burrs 250A, 250B are coupled to the cartridge 200, the first and second burrs 250A, 250B are axially aligned.

The cartridge 200 may be configured to connect and/or interact with other cartridges 200. Thus, when multiple cartridges 200 are separated from the coffee bean grinder 100, the cartridges may stack together for efficient storage. Each cartridge 200 may include one or more magnets to releasably couple the cartridges 200 together.

In accordance with certain aspects of the disclosure, the coffee bean grinder 100 may include a selector 286. The selector 286 may be a rotatable knob, a button, or the like and may be associated with a bearing configured to reduce friction between the selector 286 and adjacent structure. The selector 286 may be configured to selectively adjust a characteristic of the grinding device 240 in response to user input. For example, the selector 286 may be configured to adjust a distance between the first and second burrs 250A, 250B. The selector 286 may be associated with or otherwise adjacent to the intake member 180. Thus, in accordance with certain aspects of the disclosure, the selector 286 may form a portion of the intake member 180 such that the intake member 180 is rotatable relative the housing 110.

The motor 150 may be configured to selectively rotate a rotatable drive shaft 260. The rotatable drive shaft 260 may include a gear 262 coupled to the rotatable drive shaft 260 at or adjacent to a lower end of the drive shaft 260. A belt 264 may operably connect the motor 150 and the gear 262. Thus, the motor 150, via the belt 264 and gear 262, may selectively rotate the rotatable drive shaft 260. The rotatable drive shaft 260 may be coupled to a rotatable base plate 270 such that rotation of the rotatable drive shaft 260 causes the rotatable base plate 270 to rotate. The rotatable base plate 270 may be coupled to the drive shaft 260 closer to an upper end of the drive shaft 260 than the lower end.

The cartridge base 210 may include a hole 212 defined in a bottom 214 of the cartridge base 210. The hole 212 of the cartridge base 210 may be configured to receive the rotatable drive shaft 260 and rotatable base plate 270 therein. Thus, the rotatable drive shaft 260 and rotatable base plate 270 may rotate relative to the cartridge base 210.

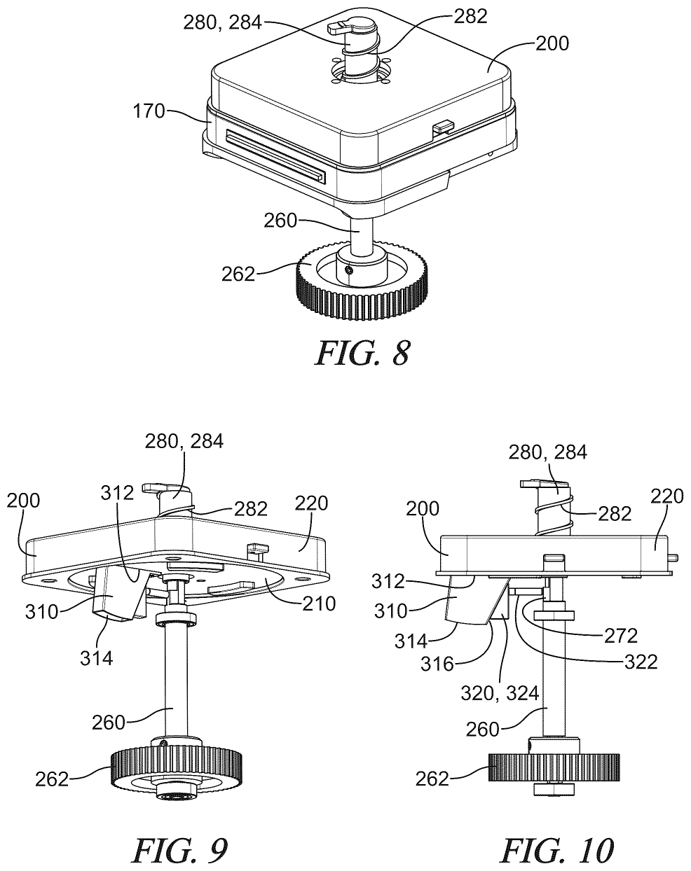

The coffee bean grinder 100 may further include a prebreaker 280, as shown in FIGS. 8-10. In accordance with certain aspects of the disclosure, the prebreaker 280 may be operably connected to the rotatable drive shaft 260 closer to the upper end of the drive shaft 260 than the lower end. In accordance with certain aspects of the disclosure, the prebreaker 280 may be removably coupled to the cartridge 200 such that it is removeable and swappable for different augers/prebreakers. The prebreaker 280 may be removably coupled via a spring-loaded cap, a push-and-click mechanism, a threaded post, magnetics, or any other coupling method. In accordance with certain aspects of the disclosure, the coffee bean grinder 100, and specifically the cartridge 200, may be operable when the prebreaker 280 is removed completely. A cap or other element may be added to the cartridge 200 to direct the coffee beans into the grinding chamber 230 when the prebreaker 280 is removed. The prebreaker 280 may be generally cylindrically shaped and include one or more ridges 282 spirally disposed about a main body 284 of the prebreaker 280. The prebreaker 280 may extend through the hole of the intake member 180 and at least partially extend through the cartridge top 220. Rotation of the rotatable drive shaft 260 may cause the prebreaker 280 to rotate. The prebreaker 280 may be configured to direct coffee beans poured into the intake member 180 into the grinding chamber 230 of the cartridge 200. In accordance with certain aspects of the disclosure, the prebreaker 280 may be configured to break the coffee beans fed into the grinding chamber 230 and/or control the rate at which the coffee beans enter into the grinding chamber 230.

In accordance with certain aspects of the disclosure, the coffee bean grinder 100 may include a hopper. The hopper may be positioned adjacent the grinding chamber 230 and may be configured to receive unground coffee beans. The hopper may dispense a desired amount of coffee beans into the grinding chamber 230 in response to user input.

The first burr 250A may be removably coupled to the cartridge top 220. The first burr 250A may be coupled such that the first burr 250A may not rotate (i.e. be substantially fixed) relative to the cartridge top 220. The second burr 250B may be removably coupled to the rotatable base plate 270. The second burr 250B may be coupled such that the second burr 250B is driven by the rotatable drive shaft 260 and rotatable base plate 270. Thus, the second burr 250B may be configured to selectively rotate relative to the first burr 250A such that coffee beans positioned between the first and second burrs 250A, 250B are ground into coffee grounds. Each of the first and second burrs 250A, 250B may include positioning posts 252 configured to be received within indentations defined in the cartridge top 220 and rotatable base plate 270, respectively. The positioning posts 252 may be configured to axially align the first and second burrs 250A, 250B. Each of the first and second burrs 250A, 250B may be coupled by magnets, screws, bolts, or other fasteners.

The cartridge base 210 may be configured to receive the coffee grounds from the grinding device 240. The cartridge 200 may be configured such that the coffee grounds exit the cartridge 200 through exit 216. Exit 216 may be defined in the bottom 214 of the cartridge base 210. In accordance with certain aspects of the disclosure, the exit 216 may be rectangular in shape. In accordance with other aspects of the disclosure, the exit 216 may be non-rectangular in shape. After being ground by the grinding device 240, the coffee grounds may collect on the bottom 214 of the cartridge base 210.

The cartridge 200 may include a plurality of sweeper arms 290 removably coupled to the rotatable base plate 270, as shown in FIGS. 12-13 and 14A-15D. In accordance with certain aspects of the disclosure, each of the plurality of sweeper arms 290 may include two or more pieces wherein some of the pieces are rigid and some are flexible. Each of the plurality of sweeper arms 290 may include a sweeper arm base 292 and a walled portion 294. The plurality of sweeper arms 290 may be configured to rotate in association with the rotatable base plate 270 and direct the coffee grounds resting on the cartridge base 210 to the exit 216 of the cartridge base 210. Each of the plurality of sweeper arms 290 may be configured to intersect the exit 216 at an angle. One exemplary advantage of this configuration may be that noise is reduced when the plurality of sweeper arms 290 touch a lower or higher point in the grinding chamber 230.

The sweeper base 292 may extend radially from the rotatable base plate 270. The sweeper base 292 may extend out toward the sidewall of the cartridge base 210 but may not contact the sidewall of the cartridge base 210. In accordance with certain aspects of the disclosure, the sweeper base 292 may be positioned a distance above the bottom 214 of the cartridge base 210 and be rigid. The walled portion 294 may be configured to be attached, coupled, or otherwise connected to the sweeper base 292. In accordance with certain optional embodiments, a front face of the walled portion 294 may include a curved portion and a substantially flat portion. The walled portion 294 may be flexible or semi-flexible. The walled portion 294 may be positioned such that it contacts the sidewall of the cartridge base 210 and the bottom 214 of the cartridge base 210.

The walled portion 294 may be removably coupled to the sweeper base 292 such that a user may select and attach certain walled portions 294 based on desired use. In accordance with certain aspects of the disclosure, the user may select certain walled portions 294 based on the pair of burrs 250 selected. In accordance with certain aspects of the disclosure, the user may wish to use shorter walled portions 294 in association with larger diameter flat burrs and may wish to use the longer walled portions 294 in association with smaller diameter flat burrs. Thus, a length of the walled portions 294 may correspond to a diameter of the burrs 250 selected. The walled portions 294 may make up a difference, or at least a portion thereof, between the burrs 250 and the sidewall of the cartridge base 210.

The coffee bean grinder 100 may further include an exit chute 310 configured to receive the coffee grounds from the cartridge 200 and direct the coffee grounds to a desired location. The exit chute 310 may include a hollow body having a top end 312 and a bottom end 314 positioned opposite the top end 312. In accordance with certain optional embodiments, the top end 312 of the exit chute 310 may be larger than the bottom 214. The exit chute 310 may be positioned adjacent to the exit 216 of the cartridge base 210 such that coffee grounds from the cartridge 200 that pass through exit 216 are then received by the exit chute 310. In accordance with certain aspects of the disclosure, the exit chute 310 may be permanently attached to the cartridge base 210 or other elements of the coffee bean grinder 100. In accordance with other aspects of the disclosure, the exit chute 310 may be removably coupled such that the exit chute 310 may be cleaned. The exit chute 310 may include a screen or other mechanism located within the hollow body configured to break up clumps within the coffee grounds passing through the exit chute 310.

The exit chute 310 may be associated with a vibrator assembly 320, as shown in FIGS. 8-10. The vibrator assembly 320 may be configured to selectively vibrate, shake, and/or agitate the exit chute 310 such that coffee grounds within the exit chute 310 are dislodged. For example, coffee grounds may become stuck to an interior wall of the exit chute 310 due to humidity, temperature, or a variety of other factors. The vibrator assembly 320 may be configured to vibrate, shake, and/or agitate the exit chute 310 such that the stuck coffee grounds are dislodged from the interior walls and allowed to pass through the exit chute 310 under the influence of gravity.

In accordance with certain aspects of the disclosure, the vibrator assembly 320 may include a cylindrical plunger 322 and a vibration block 324. The vibration block 324 may be coupled on a first side to the exit chute 310 and on a second side to the cylindrical plunger 322. The vibration block 324 may be attached to a backside 316 of the exit chute 310. In accordance with certain optional embodiments, the cylindrical plunger 322 may be coupled to the exit chute 310 and thus the vibration assembly 320 may not include the vibration block 324.

The rotatable drive shaft 260 may include a tabbed portion 272. The tabbed portion 272 may be non-circular in shape and configured to intermittently contact the cylindrical plunger 322 when the rotatable drive shaft 260 rotates. Thus, the tabbed portion 272 may contact the cylindrical plunger 322 at least once per rotation of the rotatable drive shaft 260. When the tabbed portion 272 makes contact with the cylindrical plunger 322, the cylindrical plunger 322 may bend, move, or otherwise deform the cylindrical plunger 322. Movement of the cylindrical plunger 322 may be transferred to the exit chute 310 such that the exit chute 310 experiences vibration and/or agitation.

In accordance with other aspects of the disclosure, the vibration block 324 may be positioned adjacent to the exit chute 310 but not attached thereto. The rotatable drive shaft 260 may contact the vibration block 324 or elements connected thereto, thus causing the exit chute 310 to vibrate and/or agitate the exit chute 310.

A second vibrator assembly may be operably connected to the intake member 180. The second vibrator assembly may be configured to vibrate intake member 180 such that the coffee beans are agitated as they move through the intake member 180.

A third vibrator assembly may be operably connected to a portafilter associated with the coffee bean grinder 100, a portafilter holder associated with the coffee bean grinder 100, or a container configured to catch the coffee grounds that is associated with the coffee bean grinder. An exemplary portafilter holder is shown in FIGS. 16 and 17. The third vibrator assembly may be configured to vibrate the portafilter, portafilter holder, and/or container such that the coffee grounds settle and/or densify. The third vibrator assembly may perform a homogenizing process wherein the coffee grounds are leveled out and clumps within the coffee grounds are broken apart. The third vibrator assembly may also perform a densification process. The densification process may include agitating the coffee grounds such that they pack together and occupy less volume. One exemplary advantage of the third vibrator assembly may be that a user will no longer need to do any extraneous coffee preparation, such as tamping, after the coffee beans have been ground into coffee grounds. This may result in faster throughput in a commercial setting and/or less coffee ground waste.

A portafilter associated with the coffee bean grinder 100 may be positioned such that it abuts the exit chute 310, as shown in FIGS. 16-17. The portafilter may be configured to receive the coffee grounds that have passed through the exit chute 310. In certain optional embodiments, several exit chutes 310 may exist with differing exit diameters. In accordance with certain aspects of the disclosure wherein the exit chute 310 is removably coupled, the user may select an exit chute 310 with a certain exit diameter based on the size of portafilter selected. The coffee bean grinder 100 may also include a portafilter holder configured to support an associated portafilter. The portafilter holder may be configured such that the height of the portafilter may be adjusted. Thus, the portafilter height may be adjusted such that the portafilter abuts the exit chute 310, or alternatively such that a gap exists between the portafilter and exit chute 310.

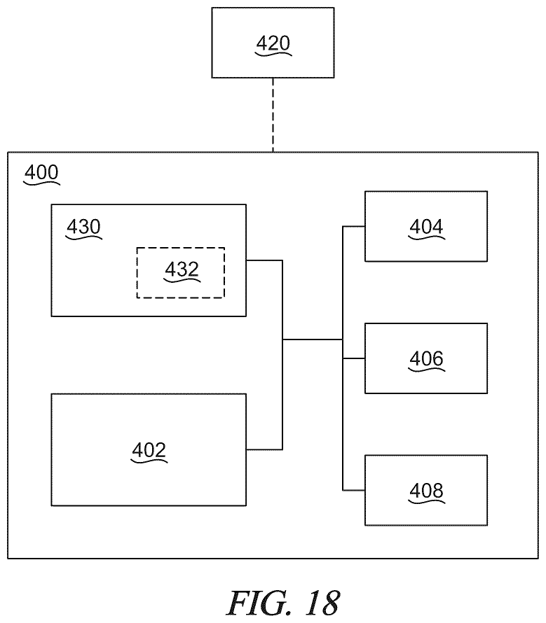

Referring now to FIG. 18, the coffee bean grinder may include a controller 400. The controller 400 may include or be associated with a processor 402, a computer-readable medium 404, a communication unit 406, and a data storage 408 such as a database network. It is understood that the controller 400 may be a single controller having some or all of the described functionality, or it may include multiple controllers wherein some or all of the described functionality is distributed among the multiple controllers. Some or all of the described functionality may for example be implemented using remote processing such as in a cloud server-based network.

Various operations, steps, or algorithms as described in connection with the controller 400 can be embodied directly in hardware, in a computer program product such as a software module executed by the processor 402, or in a combination of the two. The computer program product can reside in RAM memory, flash memory, ROM memory, EPROM memory, EEPROM memory, registers, hard disk, a removable disk, or any other form of computer-readable medium 404 known in the art. An exemplary computer-readable medium 404 can be coupled to the processor 402 such that the processor 402 can read information from, and write information to, the memory/storage medium 404. In the alternative, the medium 404 can be integral to the processor 402. The processor 402 and the medium 404 can reside in an application specific integrated circuit (ASIC). The ASIC can reside in a user terminal. In the alternative, the processor 402 and the medium 404 can reside as discrete components in a user terminal.

The term “processor” 402 as used herein may refer to at least general-purpose or specific-purpose processing devices and/or logic as may be understood by one of skill in the art, including but not limited to a microprocessor, a microcontroller, a state machine, and the like. A processor 402 can also be implemented as a combination of computing devices, e.g., a combination of a DSP and a microprocessor, a plurality of microprocessors, one or more microprocessors in conjunction with a DSP core, or any other such configuration.

The communication unit 406 may support or provide communications between the resident controller 400 and external communications units, systems, or devices, and/or support or provide a communication interface with respect to components of the coffee bean grinder 100. The communication unit 406 may include wireless communication system components (e.g., via cellular modem, WiFi, Bluetooth, or the like) and/or may include one or more wired communications terminals such as universal serial bus ports.

The data storage 408 may, unless otherwise stated, generally encompass hardware such as volatile or non-volatile storage devices, drives, electronic memory, and optical or other storage media, as well as in certain embodiments one or more databases residing thereon. In an optional embodiment, the data storage 408 may be configured to receive and retrievably store data sets, models, and/or algorithms, for further performing programmatic operations or the like as further disclosed herein.

The coffee bean grinder 100 may include one or more sensors 420 associated therewith. The one or more sensors 420 may be configured to detect one or more operating characteristics of the coffee bean grinder 100 and/or one or more characteristics of the cartridge 200 removably coupled to the coffee bean grinder 100. For example, the cartridge 200 and/or the burrs 250 may include a unique identifier such as a QR code to name one example. The one or more sensors 420 may be configured to detect which cartridge 200 and/or burrs 250 are coupled to the coffee bean grinder 100 or other information associated therewith. In accordance with certain aspects of the disclosure, the one or more sensors 420 may be configured to detect a distance between the first burr 250A and the second burr 250B; humidity in a variety of areas of the coffee bean grinder 100; water composition of the coffee beans and/or coffee grounds; temperature of a variety of areas of the coffee bean grinder such as the grinding chamber 230, the cartridge 200, specific surfaces of the burrs 250, the motor 150, and the coffee grounds; ambient temperature inside and/or outside of the coffee bean grinder 100; vibration; rotational speed of the rotatable drive shaft 260 and/or burrs 250; elevation; noise; coffee bean data such as the origin, roast date, name of coffee, specifics about the processing of the coffee beans, elevation of the coffee farm, type of coffee, roast level, and/or any other relevant data; and other characteristics of the coffee bean grinder 100.

Data detected by the one or more sensors 420 may be stored by the controller 400, and specifically by the data storage 408. The data may be available for the user and/or controller 400 to reference. The controller 400 may provide the user and/or controller 400 with suggested settings or operating variables based at least in part on the stored data. The controller 400 may employ machine learning techniques in association with the collected data to, for example, adjust and/or suggest settings or operating variables. In accordance with certain aspects of the disclosure, for example, a person could request the coffee bean grinder 100 to assist them with grinding the coffee beans and/or further brewing a coffee that someone else has consumed. The coffee bean grinder 100 may use previously collected data to assist the current user in making a similar cup of coffee, for example by adjusting certain settings or operating conditions.

In accordance with certain aspects of the disclosure, the unique identifier associated with the cartridge 200 and/or burrs 250 may direct a user to a website containing product registration fields, help documentation, and/or other relevant information.

In accordance with certain aspects of the disclosure, the coffee bean grinder 100 may include a user interface 430. The user interface 430 may be associated with a display 432 located on the housing 110 as shown in FIGS. 1-6. Alternatively or in addition, the display 432 may be associated with an application associated with a mobile device or the like. The user interface 430 may accept operator input and/or may communicate data to the user. The user may control various functions of the coffee bean grinder 100 via the user interface. For example, an electric motor or like device may adjust the distance between the first and second burrs 250A, 250B in response to operator input received via the user interface.

In accordance with certain aspects of the disclosure, the coffee bean grinder 100 may include one or more ionizers configured to reduce static and/or positive charges and/or negative charges that would cause the coffee grounds to remain in the grinding chamber 230 or other areas of the coffee bean grinder 100.

In accordance with certain aspects of the disclosure, a user may wish to grind coffee beans into coffee grounds using the coffee bean grinder 100 as disclosed herein. The user may load the coffee beans into the intake member 180. The intake member 180 may funnel or direct the coffee beans into the cartridge 200. The prebreaker 280 may direct or guide the coffee beans through the intake member 180 and into the cartridge 200. Coffee beans may become lodged between the prebreaker 280 and the intake member 180 and break apart. The coffee beans may enter into the grinding chamber 230 and be contacted by the first and second burrs 250A, 250B. The second burr 250B may rotate relative to the first burr 250A such that the coffee beans are ground into coffee grounds. The coffee grounds may collect along the cartridge base 210. The plurality of sweeper arms 290 may guide/direct the coffee grounds toward the exit 216. After entering the exit 216, the coffee grounds may pass through the exit chute 310 and be deposited in the portafilter. The vibrator assembly 320 may vibrate/shake the exit chute 310 such that any coffee grounds stuck within the exit chute 310 are dislodged.

The coffee bean grinder 100 of the present disclosure may be associated with several advantages. One such advantage may be that commercial coffee shops where the coffee bean grinder is under constant use may be able to produce more consistent coffee grounds. The one or more sensors 420 may detect the temperature of the burrs 250 and alert the user when they have reached a predetermined threshold temperature. The user may then remove the cartridge 200 from the coffee bean grinder 100 and insert a new cartridge 200 with burrs 250 that are at an ambient temperature. Alternatively, the user may remove the cartridge 200, swaps the burrs 250 contained therein, and insert the cartridge 200 back into the coffee bean grinder 100 with burrs that are at an ambient temperature. Thus, the coffee grounds will not be burned by the burrs 250. Further, the coffee grounds may be more consistent leading to fewer coffee grounds being disposed of. Another advantage may be that only a single coffee bean grinder is needed for multiple burr types. For example, a coffee shop wishing to have both a flat burr grinder and a conical burr grinder can use only the coffee bean grinder 100 disclosed herein and swap the burrs 250 contained within the cartridge 200.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A coffee bean grinder, comprising:
a housing configured to receive coffee beans; and
a cartridge removably couplable to the housing, the cartridge including:
a cartridge base;
a cartridge top removably coupled to the cartridge base;
a grinding chamber defined between the cartridge base and the cartridge top; and
a grinding device positioned within the grinding chamber and configured to grind coffee beans received in the housing into coffee grounds.

2. The coffee bean grinder of claim 1, wherein:
the grinding device includes a pair of burrs, the cartridge configured to receive a conical pair of burrs and a flat pair of burrs.

3. The coffee bean grinder of claim 2, wherein:
the pair of burrs includes a first burr and a second burr, the second burr coupled to a rotatable base plate, the first burr coupled to the cartridge top, the second burr configured to selectively rotate relative the first burr.

4. The coffee bean grinder of claim 3, wherein:
the cartridge base is configured to receive the coffee grounds from the grinding device; and
the cartridge includes a plurality of sweeper arms coupled to the base plate, the plurality of sweeper arms configured to direct the coffee grounds in the cartridge base to an exit of the cartridge base.

5. The coffee bean grinder of claim 1, further comprising:
an exit chute configured to receive the coffee grounds from the cartridge and direct the coffee grounds to a desired location.

6. The coffee bean grinder of claim 5, further comprising:
a vibrator assembly associated with the exit chute, the vibrator assembly configured to selectively vibrate the exit chute.

7. The coffee bean grinder of claim 6, further comprising:
a rotatable drive shaft configured to rotate at least a portion of the grinding device; and
wherein the drive shaft is configured to vibrate the exit chute via the vibrator assembly.

8. The coffee bean grinder of claim 7, wherein:
the vibrator assembly includes a cylindrical plunger and a vibration block, the vibration block coupled on a first side to the exit chute and on a second side to the cylindrical plunger; and
the drive shaft includes a tabbed portion, the tabbed portion of the drive shaft is configured to intermittently contact the cylindrical plunger when the drive shaft rotates such that the vibration assembly vibrates the exit chute.

9. The coffee bean grinder of claim 1, further comprising:
one or more sensors associated with the coffee bean grinder, the one or more sensors configured to detect an operating characteristic of the coffee bean grinder.

10. The coffee bean grinder of claim 1, further comprising:
one or more sensors associated with the coffee bean grinder, the one or more sensors configured to detect a characteristic of the cartridge removably coupled to the coffee bean grinder.

11. The coffee bean grinder of claim 1, further comprising:
a prebreaker removably coupled to the cartridge, the prebreaker being cylindrically shaped and at least partially extending through the cartridge top, the prebreaker configured to direct coffee beans into the grinding chamber of the cartridge.

12. The coffee bean grinder of claim 1, further comprising:
a selector configured to selectively adjust a characteristic of the grinding device.

13. The coffee bean grinder of claim 1, wherein:
the grinding device includes a pair of burrs; and
the cartridge is configurable in a flat configuration wherein the cartridge receives a pair of flat burrs and a conical configuration wherein the cartridge receives a pair of conical burrs.

14. The coffee bean grinder of claim 13, wherein:
the cartridge is configurable in a combination configuration wherein the cartridge receives at least one flat burr and at least one conical burr.

15. A cartridge configured to be removably couplable to a coffee bean grinder, the cartridge comprising:
a cartridge base;
a cartridge top removably coupled to the cartridge base;
a grinding chamber defined between the cartridge base and the cartridge top; and
a pair of burrs received by the grinding chamber and configured to grind coffee beans into coffee grounds, a first burr of the pair of burrs arranged substantially parallel to a second burr of the pair of burrs, the first burr connected to the cartridge top and fixed relative thereto, the second burr operably connectable to a shaft and configured to be rotatably driven thereby.

16. The cartridge of claim 12, wherein:
the cartridge is configured to receive a conical pair of burrs and a flat pair of burrs.

17. The cartridge of claim 12, wherein:
the second burr is coupled to a rotatable base plate and configured to selectively rotate relative to the first burr.

18. The cartridge of claim 12, wherein:
the cartridge base is configured to receive the coffee grounds from the pair of burrs; and
the cartridge further includes a plurality of sweeper arms coupled to a base plate, the plurality of sweeper arms configured to direct the coffee grounds in the cartridge base to an exit of the cartridge base.

19. The cartridge of claim 12, further comprising:
one or more sensors associated with the cartridge, the one or more sensors configured to detect an operating characteristic of the cartridge.

20. The cartridge of claim 12, wherein:
the cartridge is configured such that the pair of burrs may be selectively removed and replaced by a second pair of burrs.
